(19) United States
(12) Patent Application Publication
(10) Pub. No.: US 2005/0267823 A1
(43) Pub. Date: Dec. 1, 2005

(54) Balance processor for automated accounting system employing merging and consistency checks

(76) Inventor: Bernd Hartmann, Walldorf (DE)

Correspondence Address: KENYON & KENYON, 1500 K STREET NW, SUITE 700, WASHINGTON, DC, 20005, US

(21) Appl. No.: 10/855,513

(22) Filed: May 28, 2004

(51) Int. Cl. G06F 17/60

(52) U.S. Cl. 705/30

(57) ABSTRACT

A balance processor is provided in an automated multi-protocol accounting system. Given accounting objects generated according to a first accounting system, the balance processor generates new accounting objects that represent underlying transactions according to requirements of a second accounting system. This permits the system to reuse the first accounting system as much as possible. A financial system generates accounting objects for both primary and secondary accounting systems. The accounting objects for the secondary accounting system are incomplete. The business transactions refer to a small portion of the accounting objects (typically, about 10%) where the book values differ among the different accounting systems. Additional key figures for the secondary accounting objects are copied from corresponding primary accounting objects based on copy rules. The present invention relieves the system operators from providing fully capable accounting analyzers for the secondary accounting system. It also relieves an automated accounting system from having to survey a database of financial transactions, which can contain several hundred thousand or even millions of transaction records, and generate complete accounting records according to the second accounting system.

### BACKGROUND

The present invention relates to automated accounting systems that manage financial reporting for large firms, such as banks.

Multinational firms can be subject to financial reporting requirements of multiple nations. Accordingly, they are compelled to maintain accounting data in formats that coincide with the accounting policies of the various nations or, alternatively, in internationally approved formats such as the International Accounting Standards (“IAS”). Even firms that are not multi-national may face requirements to report their financial positions according to multiple accounting protocols as globalization issues induce governmental regulators or other capital markets participant to adhere to internationally accepted accounting standards such as the US-GAAP (generally accepted accounting principles) or IAS.

Most modern firms employ computer systems to record the various financial transactions they perform as part of their business and to maintain the required accounting information. The computer systems of these large firms, however, may store many millions of transaction records. To report financial data according to multiple accounting systems, each system would be required to survey every relevant transaction record, analyze the record for relevance to the accounting policy and generate new “accounting objects” representative of the transaction record. This process can take a considerable amount of time; it involves considerable computational expense.

Accordingly, there is a need in the art for an accounting system that minimizes the computational expense associated with generating accounting information for multiple accounting systems from a single set of transaction records.

### BRIEF DESCRIPTION OF THE DRAWINGS

FIG. 1 is a functional block diagram of an automated accounting system according to an embodiment of the present invention.

FIG. 2 is a flow diagram of a method according to an embodiment of the present invention.

FIG. 3 is a simplified block diagram of a computer system.

### DETAILED DESCRIPTION

Embodiments of the present invention provide a balance processor for use in an automated multi-protocol accounting system. Given accounting objects generated according to a first accounting system, the balance processor generates new accounting objects that represent underlying transactions according to requirements of a second accounting system. This permits the system to reuse the first accounting system as much as possible. To do so, generation of accounting objects for the second accounting system are based on the accounting objects for the first accounting system and on business transactions. The business transactions refer to a small portion of the accounting objects (typically, about 10%) where the book values differ among the different accounting systems. The present invention relieves the accounting system from having to survey a database of financial transactions, which can contain several hundred thousand, millions or even tens of millions of transaction records, and generate complete accounting records according to the second accounting system.

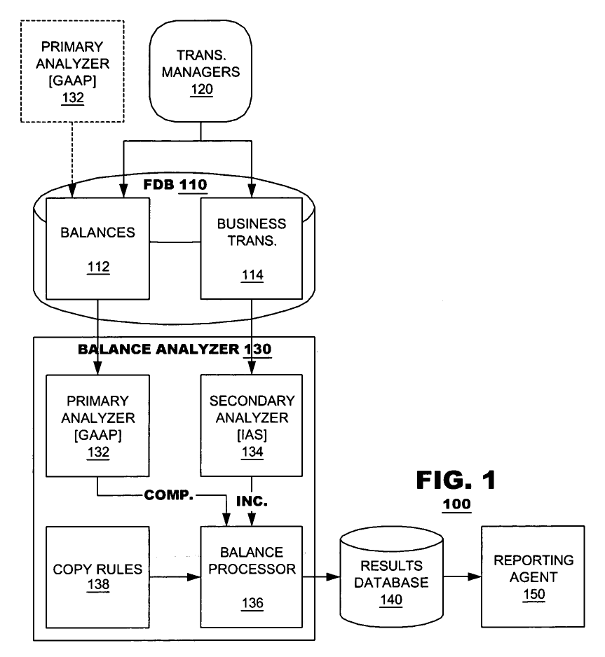

FIG. 1 is a block diagram of an automated accounting system 100 according to an embodiment of the present invention. The system may include a financial database (“FDB”) 110 that stores records of financial operations of a firm. Such records, called “FDB objects” herein, may have been generated by other elements of a firm's computer system, represented by transaction managers 120. The FDB objects may represent various types of financial data. Some FDB objects may represent account balances maintained by the firm. Other FDB objects may represent transactions performed by the firm that affect balances of the accounts. For example, with respect to operations performed by a bank, a first set of FDB objects may store balances for accounts of securities owned by the bank, for loans and other instruments managed by the bank and other bank holdings (shown as 112). A second set of FDB objects may store transaction records identifying purchases and sales of the securities (shown as 114).

The accounting system 100 also may include a balance analyzer 130 that reviews FDB objects from the FDB 110 and generates “accounting objects” therefrom. According to an embodiment of the present invention, the balance analyzer 130 includes analyzers 132, 134 for multiple accounting systems. A first analyzer 132, called the “primary analyzer,” reviews stored FDB objects from the FDB 110 and generates accounting records that create a complete accounting environment according to parameters of a first accounting system (e.g., local GAAP). A second analyzer 134, called the “secondary analyzer,” reviews stored records from the FDB 110 and generates accounting records that create an incomplete accounting environment according to parameters of a second accounting system (e.g., IAS). This calculation typically makes use of business transactions 114, which can be very elaborate. Different accounting systems may operate on different types of FDB records. For example, a local-GAAP-based accounting system operates based on FDB records representing account balances while an IAS-based accounting system operates based on FDB records representing transactions.

The balance analyzer 130 also may include a balance processor 136 that supplements accounting objects output from the secondary analyzer to complete the accounting environment according to the second accounting system. The balance processor 136 operates in conjunction with copy rules 138 that identify accounting objects output from the primary analyzer 132 that are bases for generating supplementary data for the accounting objects output from the secondary analyzer 134. Accounting objects from the primary analyzer 132 and supplemented accounting objects from the secondary analyzer 136 may be stored in a results database 140 for further use. For example, a reporting agent 150 may aggregate values across a plurality of like-kind accounting objects to generate electronic or paper accounting reports.

In another embodiment, the FDB 110 itself may store records already assembled according to one of the accounting systems used by the balance analyzer 130. That is, a transaction manager 120 may generate records according to specifications of the primary analyzer 132. FIG. 1 illustrates a primary analyzer 132 (in phantom) as an input to the FDB 110 to illustrate this embodiment.

According to an embodiment, an accounting object may be represented by three types of information: defining characteristics, describing characteristics and key figures. “Key figures” are numbers representing parameter data of FDB records; they are the numbers which are used for financial calculation by the primary and secondary analyzers. “Characteristics” are semantic identifiers of key figure data; they may identify various parameters FDB records (e.g., object ID, security ID) or may provide for differentiation among reporting entities (e.g., a legal entity, a profit center, an instrument type). Decisions regarding which characteristics (of either type) and which key figures are to be used in a system typically are made during system installation. Indeed, different accounting object types are permissible in certain installations. Some defining characteristics tend to be used from installation to installation because they are germane to various banking operations. These defining characteristics include, for example, legal entity, security ID and loan ID.

In one embodiment, the copy rules identify key figures that are to be copied from the primary analyzer's accounting objects to the secondary analyzer's accounting objects. Different combinations of copy rules are permissible. Typically, a copy rule will be defined for each accounting object that matches a predetermined set of characteristics. Primary and secondary accounting objects may be paired together if they possess a matching set of defining characteristics, for example, the same security ID, the same legal entity and the same holding category. For each pair of accounting objects, the balance analyzer 136 may compare select characteristics fields to those fields identified in the copy rules 138 and, upon a match, the balance analyzer 136 may copy key figures from the primary analyzer's AO to the secondary analyzer's AO as dictated by the matching rule.

A pair of exemplary copy rules is illustrated in Table 1 below. As shown, each rule identifies a set of matching criteria and a set of copy schemes. Characteristics fields “accounting object type” and “delivery type” are shown in this example but other characteristics may be used for copy rules as desired by an operating firm. The copy rules each identify which key figures are to be copied from the primary object and which key figures are to be copied from the secondary object. Of course, key figures may be taken entirely from, for example, the primary object as determined by an operator. Such an example is shown for rule 2 in Table 1.

| MATCHING CRITERIA | RULE 1 | RULE 2 |
|---|---|---|
| ACCOUNTING OBJECT TYPE | bond | bond |
| DELIVERY TYPE | mixed | all FDB |

TABLE 1

| KEY FIGURE | | PRIMARY |
|---|---|---|
| SOURCE | PRIMARY OBJECT | OBJECT |
| | interest income from amortization | face value |
| | interest income pro rata | book value |
| | accrued interest | revaluation reserve |
| | interest income from nominal | interest income |
| | interest | from amortization |
| | interest income pro rata | |
| | accrued interest | |
| | interest income from nominal | |
| | interest | |

| SECONDARY OBJECT | SECONDARY OBJECT |
|---|---|
| face value | — |
| book value | |
| revaluation reserve | |
| trading profit/loss | |

Consider the copy rules in operation in connection with hypothetical accounting data. In this example, on Dec. 10, 2003, a bank purchases bonds having a face value of $2000 for a purchase price of $1800 and, on Jun. 10, 2004, sells a portion of the bonds having a face value of $1000 for $950. The transactions portion of the database records the transaction data directly. Further, other data objects within the database may store positions information at Dec. 31, 2003 and Jun. 30, 2004 respectively. Thus, the FDB 100 may store the following data objects:

TABLE 2

| TRANSACTION OBJECTS | TRANSACTION 1 | TRANSACTION 2 |
|---|---|---|
| legal entity | BANK01 | BANK01 |
| security id | US67000003 | US67000003 |
| holding category | available-for-sale | available-for-sale |
| business transaction type | Buy | Sell |
| date | Dec/10/2003 | Jun/10/2004 |
| face value | −2000 | −1000 |
| purchase price | −1800 | −950 |

TABLE 3

| BALANCES OBJECTS | POSITION 1 | POSITION 2 |
|---|---|---|
| legal entity | BANK01 | BANK01 |
| security id | US67000003 | US67000003 |
| holding category | available-for-sale | available-for-sale |
| date | Dec/31/2003 | Jun/30/2004 |
| instrument type | bond | bond |
| delivery type | mixed | mixed |
| face value | −2000 | −1000 |
| book value | −1800 | −900 |
| interest income pro rata | 30 | 45 |
| accrued interest | −30 | −45 |
| interest income from nominal | 120 | 120 |
| interest | | |
| trading profit/loss | | 49 |

Accounting objects derived from these FDB objects are shown in Table 4 and Table 5. Table 2 illustrates exemplary primary and secondary accounting objects that are input to the balance processor 136. These accounting objects include the same characteristics (e.g., legal entity, security ID, etc.) but typically include different key figures from each other. The key figures for each accounting object are determined based on the accounting systems that the respective accounting objects support.

TABLE 4

| | | | SECONDARY | |
|---|---|---|---|---|
| | | | ACCOUNTING OBJECT | |
| PRIMARY ACCOUNTING OBJECT | | | [BEFORE MERGE] | |
| legal entity | BANK01 | CHARACTERISTICS | legal entity | BANK01 |
| security id | US67000003 | | security id | US67000003 |
| holding category | available-for- | | holding category | available-for- |
| | sale | | | sale |
| date | Dec/31/2003 | | date | Dec/31/2003 |
| instrument type | bond | | instrument type | bond |
| delivery type | mixed | | delivery type | mixed |
| face value | −2000 | KEY FIGURES | face value | −2000 |
| book value | −1800 | | book value | −1920 |
| interest income pro rata | 30 | | revaluation reserve | 80 |
| accrued interest | −30 | | interest income from | 40 |
| | | | amortization | |
| interest income from nominal | 120 | | trading profit/loss | 0 |
| interest | | | | |
| trading profit/loss | | | | |

Table 5 illustrates key figures for the secondary accounting object after the copy rules of Table 1 are applied. As discussed, the balance processor identifies secondary accounting object(s) which correspond to a primary accounting object based upon matching rules. Thereafter, it determines the copy rule that match the parameter's instrument type and delivery type. Accordingly, the balance processor copies the key figures from the primary accounting object as specified in the rule, generating results as shown in Table 5.

TABLE 5
SECONDARY ACCOUNTING OBJECT [AFTER MERGE]

| legal entity | BANK01 |
|---|---|
| security id | US67000003 |
| holding category | available-for-sale |
| date | Dec/31/2003 |
| instrument type | bond |
| delivery type | mixed |
| face value | −2000 |
| book value | −1920 |
| revaluation reserve | 80 |
| interest income from amortization | 40 |
| interest income pro rata | 30 |
| accrued interest | −30 |
| interest income from nominal interest | 120 |
| trading profit/loss | 0 |

This revised secondary accounting object may be stored in the results database 140.

According to an embodiment of the present invention, the balance analyzer also performs a consistency check to determine whether financial errors have been introduced by the copying operation. When the copying operation concludes, the balance analyzer 136 possesses two accounting objects representative of the same basic financial transaction. The first AO is generated from the primary analyzer 132. The second AO is generated from the secondary analyzer 134 but has been supplemented according to the copy operation performed by the balance analyzer 136. Although these two AOs may apportion financial data among different key figures, the financial data should agree in total.

The consistency check operation causes the balance analyzer 136 to sum all financial values in each accounting object to determine whether they agree. If so, the AO pair passes the consistency check operation. If not, an error results. The system's response to the error may depend upon the magnitude of a differential (Δ) between the two AOs.

Further checks can be defined during the implementation at the customer side. For example a comparison of the face values of the primary accounting objects and the secondary accounting objects might be defined.

Table 6 illustrates system response to error events according to an embodiment of the present invention. For illustrative purposes, financial amounts of accounting objects are represented as being in Euros.

TABLE 6

| | MESSAGE | | RANGE |
|---|---|---|---|
| EVENT | TYPE | REACTION | OF DIFFERENCE [Δ] |
| No variance | No message | Save the difference | \|Δ\| ≦ [symbol] 2 |
| Level 1 | Note to Log | Save the difference | [symbol] 2 < \|Δ\| < [symbol] 50 |
| Level 2 | Warning | Save the difference | [symbol] 50 \|Δ\| < [symbol] 500 |
| Level 3 | Error | Reject, transfer | [symbol] 500 \|Δ\| |
| | | primary system | |
| | | values | |

As shown in Table 6, the system may provide a graduated response to differentials between accounting objects. In this example, any differential value Δ less than [symbol] 500 will be accepted. If the differential value Δ is [symbol] 2 or less, no messages are created. If the differential value Δ is between [symbol] 2 and 50, the system may record a note to an information log. If the differential value Δ is between [symbol] 50 and 500, the system may generate an affirmative alert to a system operator or the like indicating the error.

The level of differential values may be customized at the customer site according to the needs of the customer. Some differential values Δ may be so severe that it causes the supplemented AO to be rejected. In the example of Table 6, differential values of [symbol] 500 or more would cause rejection. Additionally, an alert may be generated to a system operator to identify the error. Typically, such high errors may occur from inconsistent data stored in the FDB 110 from various transaction managers 120. In such a case, the balances 112 and business transactions 114 would not match. Thus, the consistency check mechanism provided by the present invention can identify data consistency errors introduced in earlier stages of a accounting system 100.

According to an embodiment, when the system accepts a secondary accounting object with a differential error, the system may generate a new key figure, called the “merge difference” herein, to record the differential and bring the two accounting objects into balance.

Table 7 illustrates a pair of accounting objects that are in balance. In this example, the primary accounting object is generated according to the German-GAAP accounting system. The secondary accounting object is generated according to IAS. Table 7 illustrates characteristics for the accounting objects, including the security ID, delivery type and instrument type. In this example, the accounting object represents a warrant bond.

Although the two accounting objects may store different value for the book value, revaluation reserved and interest income from amortization, the key values sum to the same value. These two accounting objects are in balance.

TABLE 7

| | | GAAP | IAS |
|---|---|---|---|
| CHAR. | Security ID | 670000 | 670000 |
| | Delivery Type | Mixed | Mixed |
| | Instrument Type | Warrant Bond | Warrant Bond |
| | | Cumulative | Cumulative |
| KEY | Book Value | −1,200 | −1,300 |
| FIGURES | Interest Income Pro | 15 | 15 |
| | Rata (P/L Statement) | | |
| | Pro Rata Accrued Interest | −15 | −15 |
| | Revaluation Reserves | | 120 |
| | for Instrument | | |
| | Paid Interest | −40 | −40 |
| | Interest Income from | 60 | 60 |
| | Nominal Interest | | |
| | Interest Income from | | −20 |
| | Amortization | | |
| | Cumulated Result | | |
| | Difference | | |
| | TOTAL | −1,180 | −1,180 |

Table 8 illustrates another set of key figures for the same warrant bond. In this example, the key figures do not sum to the same value. There is a difference of [symbol] 20 between them. According to the response defined in Table 6 above, the merge error would be noted in an information log maintained by the system but the secondary accounting object (here, the IAS object) would be accepted into the system. A merge difference key figure would be stored with— [symbol] 20 to bring the two accounting objects into balance.

TABLE 8

| | | GAAP | IAS |
|---|---|---|---|
| CHAR. | Security ID | 670000 | 670000 |
| | Delivery Type | Mixed | Mixed |
| | Instrument Type | Warrant Bond | Warrant Bond |
| | | Cumulative | Cumulative |
| KEY | Book Value | −1,200 | −1,280 |
| FIGURES | Interest Income Pro Rata | 15 | 15 |
| | (P/L Statement) | | |
| | Pro Rata Accrued Interest | −15 | −15 |
| | Revaluation Reserves | | 120 |
| | for Instrument | | |
| | Paid Interest | −40 | −40 |
| | Interest Income from | 60 | 60 |
| | Nominal Interest | | |
| | Interest Income from | | −20 |
| | Amortization | | |
| | Cumulated Result | | |
| | Difference | | |
| | Merge Difference [Δ] | | −20 |
| | TOTAL BEFORE MERGE | −1,180 | −1,160 |
| | DIFFERENCE | | |
| | CALCULATION | | |
| | TOTAL AFTER MERGE | −1,180 | −1,180 |
| | DIFFERENCE | | |
| | CALCULATION | | |

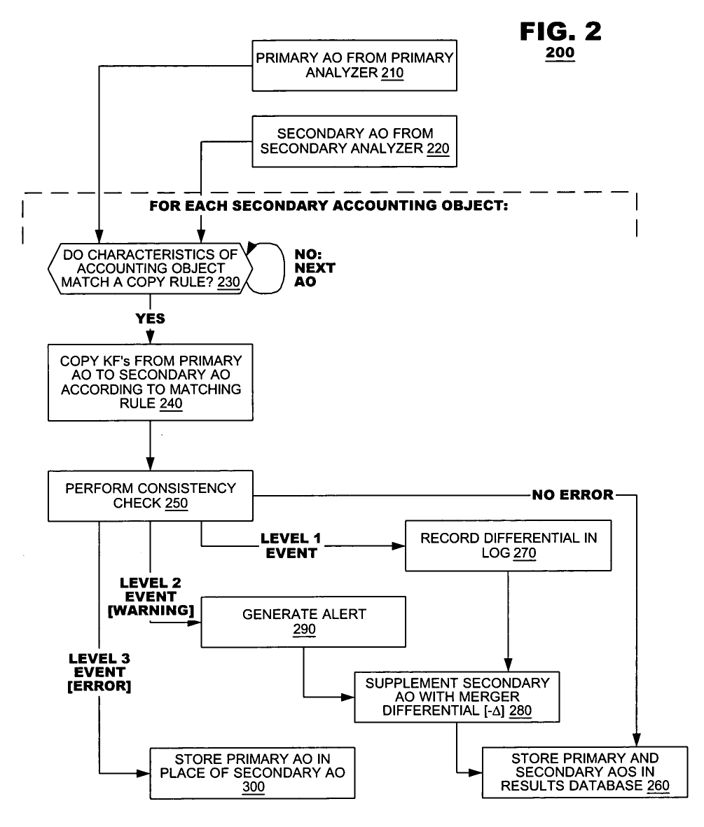

FIG. 2 illustrates a method of operation 200 according to an embodiment of the present invention. As shown in FIG. 2, the method 200 has access to primary accounting objects and secondary accounting objects generated from respective accounting analyzers, such as analyzers 132, 134 of FIG. 1 (boxes 210, 220). The method may survey each of the secondary accounting objects and, for each, determine the corresponding primary object by making use of the defining characteristics. (box 230). If so, the method may copy key figure data from a corresponding primary accounting object to the secondary accounting object as specified by the matching rule (box 240). If not, the method may generate an error or simulate a primary object where all key figures equal to zero.

Following the copying, the method 200 may perform a consistency check (box 250). As indicated, a variety of outcomes are possible. If the consistency check reveals that the primary and supplemented secondary accounting objects are balanced, no error is detected and the accounting objects may be stored in the results database (box 260). If a low-level error is detected, shown as a level 1 event, a record of the differential may be created in a system log (box 270) and the secondary accounting object may be supplemented with a merger difference as shown in Table 8 (box 280). Thereafter, the primary accounting object and the supplemented secondary accounting object may be stored in the results database (box 260).

If a moderate level error is detected, shown as a “level 2” event, the system may generate an alert such as by generating a pop-up system message, an e-mail or other affirmative alert to a system operator (box 290). Thereafter, the method may supplement the secondary accounting object with a merger difference key figure (box 280) and store the primary and supplemented secondary accounting objects in the results database (box 260).

If a severe error is detected, shown as a level 3 event the system may reject the secondary accounting object (box 300). Instead, the system may store a copy of the primary accounting object in the results database in place of the secondary accounting object or, alternatively, the system may query an operator for manual entry of data to be used as key figure data in the secondary accounting object (steps not shown).

Returning to the example of Table 1, Table 9 illustrates primary and secondary accounting objects that might be stored by the FDB 110 following the June 10 sale of a portion of the bonds. In this example, the secondary accounting object of Table 9 reflects parameters of the sale and would be created as part of the sale transaction. The primary accounting object shows balance data on a predetermined date, e.g., the end of a fiscal quarter.

TABLE 9

| | | | SECONDARY ACCOUNTING OBJECT | |
|---|---|---|---|---|
| PRIMARY ACCOUNTING OBJECT | | | [BEFORE MERGE] | |
| legal entity | BANK01 | CHARACTERISTICS | legal entity | BANK01 |
| security id | US67000003 | | security id | US67000003 |
| holding category | available-for- | | holding category | available-for- |
| | sale | | | sale |
| date | Jun/30/2004 | | date | Jun/10/2004 |
| instrument type | bond | | instrument type | bond |
| delivery type | mixed | | delivery type | mixed |
| face value | −1000 | KEY FIGURES | face value | −1000 |
| book value | −900 | | book value | −980 |
| interest income pro rata | 45 | | revaluation reserve | 50 |
| accrued interest | −45 | | interest income from | 10 |
| | | | amortization | |
| interest income from nominal | 120 | | trading profit/loss | 30 |
| interest | | | | |
| trading profit/loss | 49 | | cumulated profit difference | 40 |

Following operation of the copy rules, the secondary accounting object may contain data as shown in Table 10. Note that, in this example, the copy operation gives rise to a merge difference value of 1, which might be considered below a level 1 error under the hierarchy of Table 6. In this case, the merge difference could be stored in the secondary accounting object without requiring storage of a corresponding log entry by the system.

TABLE 10
SECONDARY ACCOUNTING OBJECT [AFTER MERGE]

| legal entity | BANK01 |
|---|---|
| security id | US67000003 |
| holding category | available-for-sale |
| date | Jun/30/2004 |
| instrument type | bond |
| delivery type | mixed |
| face value | −1000 |
| book value | −980 |
| revaluation reserve | 50 |
| interest income from amortization | 10 |
| interest income pro rata | 45 |
| accrued interest | −45 |
| interest income from nominal interest | 120 |
| trading profit/loss | 30 |
| cumulated profit difference | 40 |
| merge difference | −1 |
| sum | −731 |

Table 10 also identifies a cumulated profit difference field. During the year end closing operations, firms typically initialize their profit/loss accounts by transferring the respective amounts to equity capital. The present invention introduces a new process for the year end closing operations: For every pair of primary and secondary accounting objects, a key figure called “actual profit difference” is calculated, which is the difference of all profit/loss key figures of secondary accounting objects and the primary accounting objects of the actual fiscal year. At the year end closing the cumulated profit difference is updated by adding the actual profit difference to cumulated profit difference of the previous year. This key figure reflects the difference in equity capital in the two accounting systems caused be the accounting object. This key figure must be included in the consistency check. The total equity capital of a legal entity in the secondary accounting system is calculated as follows:
equity capital sec. Acc. System=equity capital prim. Acc. System+cumulated profit differences of all accounting objects.
Accordingly, the balance processor 136 may calculate incremental cumulated profit difference key figures for each secondary object. Thereafter, during the reporting process, the total equity capital calculations may be calculated from these incremental key figures.

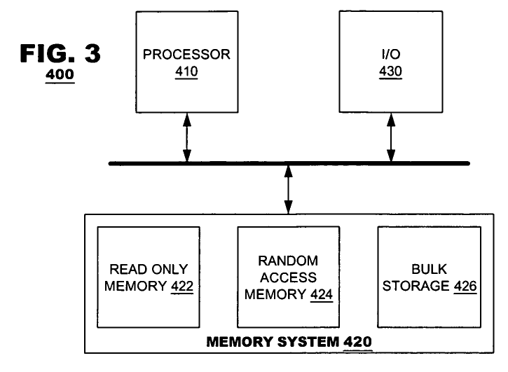

Functionality of the foregoing embodiments may be provided on various computer platforms executing program instructions. One such platform 400 is illustrated in the simplified block diagram of FIG. 3. There, the platform 400 is shown as being populated by a processor 410, a memory system 420 and an input/output (I/O) unit 430. The processor 410 may be any of a plurality of conventional processing systems, including microprocessors, digital signal processors and field programmable logic arrays. In some applications, it may be advantageous to provide multiple processors (not shown) in the platform 400. The processor(s) 410 execute program instructions stored in the memory system. The memory system 420 may include any combination of conventional memory circuits, including electrical, magnetic or optical memory systems. As shown in FIG. 3, the memory system may include read only memories 422, random access memories 424 and bulk storage 426. The memory system not only stores the program instructions representing the various methods described herein but also can store the data items on which these methods operate. The I/O unit 430 would permit communication with external devices (not shown).

Several embodiments of the present invention are specifically illustrated and described herein. However, it will be appreciated that modifications and variations of the present invention are covered by the above teachings and within the purview of the appended claims without departing from the spirit and intended scope of the invention.

1. A automated accounting method, comprising:
generating primary accounting objects from a subset of firm accounting objects, the primary accounting objects generating a complete accounting environment of a firm,
generating secondary accounting objects from another subset of firm stored accounting objects, the secondary accounting representing an incomplete accounting environment of the firm,
thereafter, copying select key figures from the primary accounting objects to the secondary accounting objects, wherein the secondary accounting objects represent a complete accounting environment of the firm upon conclusion of the copying.

2. The method of claim 1, wherein the copying comprises, based on a match between characteristic information of a respective secondary accounting object and corresponding information in a set of copy rules, copying key figures from the primary accounting objects to the corresponding secondary accounting object as specified in a matching copy rule.

3. The method of claim 1, further comprising storing of the primary accounting objects and supplemented secondary accounting objects in a database.

4. The method of claim 1, wherein the primary accounting objects represent financial data according to a accounting system.

5. The method of claim 1, wherein the second accounting objects analyzer represent financial data according to accounting system.

6. The method of claim 1, wherein one of the primary and secondary accounting objects represent transactional data and the other of the primary and secondary accounting objects represent positions data.

7. The method of claim 1, further comprising comparing the primary accounting objects to the corresponding secondary accounting objects to determine whether a consistency error occurred.

8. The method of claim 7, wherein comparing comprises:
summing key figures from the primary accounting objects,
summing key figures from the corresponding secondary accounting objects, and
determining a differential between the two sums.

9. A consistency check method for an automated accounting system, comprising:
generating primary accounting objects representing firm transactions according to a first accounting system, the primary accounting objects representing a complete accounting environment,
generating secondary accounting objects representing the firm transactions according to a second accounting system, the secondary accounting objects representing an incomplete accounting environment,
supplementing the secondary accounting objects by copying key figures from corresponding primary accounting objects, wherein the supplemented accounting objects represent a complete accounting environment,
summing key figures for the primary accounting objects and for the corresponding secondary accounting objects, and
if a differential exists between the sums, based on a magnitude of the differential, generating an error message.

10. The consistency check method of claim 9, wherein the copied key figures are identified by copy rules that match characteristic information of the respective secondary accounting object.

11. The consistency check method of claim 9, wherein different error messages are generated for different differential magnitudes.

12. The consistency check method of claim 11, wherein the error message is recorded in a log.

13. The consistency check method of claim 11, wherein the error message is transmitted to an operator by e-mail.

14. The consistency check method of claim 11, wherein the error message is a rejection of the amended secondary accounting object.

15. A financial management system comprising:
a financial database storing accounting objects representative of financial operations and balances of a firm,
a first accounting analyzer to compute primary accounting objects from a subset of the stored accounting objects, the primary accounting objects generating a complete accounting environment of the firm,
a second accounting analyzer to compute secondary accounting objects from another subset of the stored accounting objects, the secondary accounting representing an incomplete accounting environment of the firm,
a balance processor, coupled to the first and second accounting analyzers, to copy select key figures from the primary accounting objects to the secondary accounting objects, wherein the secondary accounting objects represent a complete accounting environment of the firm upon conclusion of the balance processor's copying.

16. The financial management system of claim 15, wherein the balance processor operates according to copy rules, each copy rule including characteristic information that identifies which primary accounting objects are relevant to the respective rule and identifying key figures from the primary accounting objects to be copies to corresponding secondary accounting objects.

17. The financial management system of claim 15, further comprising a results database for storage of the primary accounting objects and supplemented secondary accounting objects.

18. The financial management system of claim 15, wherein the first accounting analyzer implements a national, regional or international (like IAS, US-GAAP) accounting system.

19. The financial management system of claim 15, wherein the second accounting analyzer implements a national, regional or international (like IAS, US-GAAP) accounting system.

20. The financial management system of claim 15, wherein the balance processor further performs a consistency check to determine whether the primary accounting objects and corresponding secondary accounting objects are balanced.

21. The financial management system of claim 20, wherein pursuant to the consistency check the balance processor:
sums key figures from the primary accounting objects,
sums key figures from the corresponding secondary accounting objects, and
determines a differential between the two sums.

22. A financial management system comprising:
a financial database storing accounting objects representative of financial operations and balances of a firm,
a first accounting analyzer to compute primary accounting objects from a subset of the stored accounting objects, the primary accounting objects generating a complete accounting environment of the firm,
a second accounting analyzer to compute secondary accounting objects from another subset of the stored accounting objects, the secondary accounting representing an incomplete accounting environment of the firm, and
a balance processor, coupled to the first and second accounting analyzers,
to copy select key figures from the primary accounting objects to the secondary accounting objects, wherein the secondary accounting objects represent a complete accounting environment of the firm upon conclusion of the balance processor's copying and
to perform a consistency check to determine whether the primary accounting objects and corresponding secondary accounting objects are balanced.

23. A computer readable medium having stored thereon program instructions that, when executed, cause an executing device to:
generate primary accounting objects from a subset of firm accounting objects, the primary accounting objects generating a complete accounting environment of a firm,
generate secondary accounting objects from another subset of firm stored accounting objects, the secondary accounting representing an incomplete accounting environment of the firm,
thereafter, copy select key figures from the primary accounting objects to the secondary accounting objects, wherein the secondary accounting objects represent a complete accounting environment of the firm upon conclusion of the copying.

24. The medium of claim 23, wherein the copying comprises, based on a match between characteristic information of a respective secondary accounting object and corresponding information in a set of copy rules, copying key figures from the primary accounting objects to the corresponding secondary accounting object as specified in a matching copy rule.

25. The medium of claim 23, wherein the instruction further cause the device to store of the primary accounting objects and supplemented secondary accounting objects in a database.

26. The medium of claim 23, further storing the primary accounting objects representing financial data according to a national, regional or international (like IAS, US-GAAP) accounting system.

27. The medium of claim 23, further storing the second accounting objects representing financial data according to a national, regional or international (like IAS, US-GAAP) accounting system.

28. The medium of claim 23, wherein the instruction further cause the device to compare the primary accounting objects to the corresponding secondary accounting objects to determine whether a consistency error occurred.

29. The medium of claim 23, wherein the comparing comprises:
summing key figures from the primary accounting objects,
summing key figures from the corresponding secondary accounting objects, and
determining a differential between the two sums.

30. A computer readable medium having stored thereon program instructions that, when executed, cause an executing device to:
generate primary accounting objects representing firm transactions according to a first accounting system, the primary accounting objects representing a complete accounting environment,
generate secondary accounting objects representing the firm transactions according to a second accounting system, the secondary accounting objects representing an incomplete accounting environment,
supplement the secondary accounting objects by copying key figures from corresponding primary accounting objects, wherein the supplemented accounting objects represent a complete accounting environment,
sum key figures for the primary accounting objects and for the corresponding secondary accounting objects, and
if a differential exists between the sums, based on a magnitude of the differential, generate an error message.

31. The medium of claim 31, wherein the instructions cause the device to identify copied key figures by copy rules that match characteristic information of the respective secondary accounting object.

32. The medium of claim 31, wherein the instructions cause the device to generate different error messages for different differential magnitudes.

33. The medium of claim 32, wherein the medium stores the error message in a log.

34. The medium of claim 32, wherein the instructions cause the device to transmit the error message to an operator by e-mail.

35. The medium of claim 32, wherein the instructions cause the device to reject the amended secondary accounting object.

36. A method to calculate cumulated profit difference key figure, comprising:
from a plurality of pairs of primary and secondary accounting objects, each of the accounting objects representing financial positions of a transaction according to a respective accounting system, generating incremental actual profit difference key figure,
aggregating the incremental actual profit difference key figures across a determine time period to generate the cumulated profit difference key figure.
